(19) United States
(12) Patent Application Publication
(10) Pub. No.: US 2025/0378545 A1
(43) Pub. Date: Dec. 11, 2025

(54) ACTIVE DAMAGE DETECTION SYSTEM AND METHOD FOR DETECTING CRACKS IN A SURFACE

(71) Applicant: Purdue Research Foundation, West Lafayette, IN (US)

(72) Inventors: Mohammad Reza Jahanshahi, West Lafayette, IN (US); Wen Tang, Lafayette, IN (US)

(21) Appl. No.: 19/229,863

(22) Filed: Jun. 5, 2025

Related U.S. Application Data
(60) Provisional application No. 63/656,232, filed on Jun. 5, 2024.

(51) Int. Cl. G06T 7/00; B25J 9/16; B25J 19/02; G06T 7/11

(52) U.S. Cl. CPC G06T 7/0004; B25J 9/161; B25J 9/163; B25J 9/1671; B25J 19/023; G06T 7/11; G06T 2207/20081; G06T 2207/20084; G06T 2207/20221

(57) ABSTRACT

Methods and systems for inspecting surfaces for visible damage. Such a method includes training a robotic agent to distinguish with a camera of the robotic agent whether features in the surface are cracks or scratches in the surface, and then inspecting the surface by performing an active damage segmentation (ADS) task that distinguishes between cracks and scratches in the surface by adaptively selecting different viewpoints of the first feature by moving the camera, acquiring observations with the camera corresponding to the different viewpoints, and fusing information obtained from the observations at the different viewpoints.

### CROSS-REFERENCE TO RELATED APPLICATIONS

This application claims the benefit of provisional U.S. Patent Application No. 63/656,232 filed Jun. 5, 2024, the contents of which are incorporated herein by reference.

### BACKGROUND OF THE INVENTION

The invention generally relates to systems and methods for inspecting surfaces for visible damage.

Civil infrastructure inspection based on manual inspection is time-consuming, costly, subjective, and laborious. Timely damage detection offers crucial insights into the state of civil infrastructures, helping to avert potential disasters. With the success of artificial intelligence, robotic platforms have been developed that use robots (robotic agents) to perform infrastructure assessments, including the inspection of buildings, tunnels, nuclear facilities, oil and gas facilities, and bridges. The main focus of these systems has been the hardware aspect of the robotic agent, including the effective design of robotic locomotion and sensing capabilities. Most of these systems are human-controlled, and the few autonomous systems only perform specific tasks in relatively simple environments, such as inspection of pavements on bridges, where the data collection is done through exhaustive searching. However, the conventional approaches primarily focus on coverage path planning and typically lack comprehensive consideration of uncertainties (e.g., false positive and false negative damage predictions) during data collection. Because of this, conventional systems typically do not consider an active detection (perception) problem in which the robotic agent could adaptively make decisions and navigate through the environment to increase its belief about the existence of damage.

For example, most current robotic inspection systems are based on passive detection, where the robotic agents are agnostic about the presence of the damage during data collection and passively follow a predefined path. In addition, data is typically processed and analyzed offline after it is collected. This approach presents limitations when it comes to addressing ambiguity or uncertainty encountered during data analysis, as there are no means to revisit a field that has been inspected (e.g., viewed by a camera) for further examination. In contrast, a human inspector has the capability to move in 3D environments and actively select the viewpoint to gain a better interpretation of the damage, such as, by moving closer to the potentially damaged area or viewing the same region from a different angle.

To address shortcomings of passive inspection systems, inspection systems have been investigated that utilize multi-view data fusion to analyze individual images and subsequently merge their outcomes using data fusion to reduce the occasional false predictions at certain viewpoints. Despite there being different data fusion methods proposed to improve the final prediction accuracy, little emphasis has been placed on selecting viewpoints strategically. Arguably, the ability to intelligently choose and fuse viewpoints that contain more relevant and credible information could produce more accurate results than simply collecting and fusing all available views.

Active perception is a concept that proposes strategically changing a sensor's state parameters to improve its perception capabilities. This approach seeks to actively tailor the sensing process to extract maximum information from the environment, thereby improving the robotic agent's perception and performance. Although there has been research focusing on active object recognition, such research has not focused on designing an artificial intelligent (AI) agent with active vision for damage detection.

Damage detection based on computer vision and deep learning has been a common topic of research, and there are various models that can detect and segment the damage in images reasonably well. Inspired by fully convolutional networks (e.g., FCN, U-Net) and DeepLab segmentation architectures, research has modified and applied these architectures in damage segmentation and shown promising potential for damage segmentation. However, in most studies, the images are captured from a predetermined viewpoint where the defective regions are visible with little ambiguity. In cases where shadows are falsely classified as cracks, or cracks are undetected due to poor visibility, there is no additional information available by which predictions can be modified or rectified since a static image is the only available input. Such an approach is characterized by capturing images from predetermined viewpoints without recourse for amending predictions using additional data.

In view of this, it would be desirable to have a robotic agent and/or at least partially autonomous robotic inspection system that has active perception capabilities able to interpret data as sensor(s) inspect a region and make further decisions regarding what areas to inspect at all and/or inspect further in different manners based on the data obtained during the inspection process, such that an inspection performed by a robotic agent is able to more closely resemble a human inspector's ability to actively make dynamic inspection decisions during the inspection process based on what is observed in real time.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods and systems for inspecting surfaces for visible damage.

According to a nonlimiting aspect, a method for detecting cracks in a surface includes training a robotic agent to distinguish with a camera of the robotic agent whether features in the surface are cracks or scratches in the surface, and inspecting the surface by performing an active damage segmentation (ADS) task that distinguishes between cracks and scratches in the surface by adaptively selecting different viewpoints of the first feature by moving the camera, acquiring observations with the camera corresponding to the different viewpoints, and fusing information obtained from the observations at the different viewpoints.

According to another nonlimiting aspect, an active damage detection system for detecting cracks in a surface includes a robotic agent configured to move a camera in a three-dimensional space relative to the surface. The robotic agent is operable to be trained to distinguish with the camera whether a feature in the surface is a crack or a scratch in the surface; and inspect the surface by performing an active damage segmentation task that distinguishes between cracks and scratches in the surface by adaptively selecting different viewpoints of the feature by moving the camera, acquiring observations with the camera corresponding to the different viewpoints, and fusing information obtained from the observations at the different viewpoints.

Technical aspects of inspection systems and methods as described above preferably include the utilization of an autonomous robotic agent having active perception capabilities for interpreting data collected by the robotic agent during an inspection of an area of a surface, and the ability for such a robotic agent to make decisions regarding what additional areas of the surface to inspect, what areas to reinspect, and possibly what areas do not require inspect at all based on the data obtained during the inspection process.

These and other aspects, arrangements, features, and/or technical effects will become apparent upon detailed inspection of the figures and the following description.

### BRIEF DESCRIPTION OF THE DRAWINGS

FIG. 1A schematically illustrates the framework of traditional passive damage detection, and FIG. 1B schematically illustrates the framework of active damage detection (perception) according to some aspects of the invention. In active damage detection, if the robotic agent is not confident about the existence of damage in a frame due to poor lighting conditions, the robotic agent can decide to move around and gather additional information from different viewpoints. In this way, the robotic agent tries to actively increase its confidence about the existence or absence of damage in the scene under inspection.

FIG. 2 schematically represents the overall deep reinforcement learning framework, whose objective was to train a policy network that can output the probability of action taken for the next step based on current and historical observations. After training, the robotic agent would be able to provide the next-best viewpoint given observations from the environment and use the information from the new viewpoint to iteratively improve the segmentation accuracy.

FIG. 3A schematically represents the overall architecture of an “ADS-DRL agent” that employs deep reinforcement learning (DRL) to learn a near-optimal policy for an active damage segmentation (ADS) task and approximate its solution. The ADS-DRL agent 12 comprises a policy network and a perception network, the latter including a segmentation network and a mask fusion module. FIG. 3B contains a pseudo code describing a training process for use in a training stage of the ADS-DRL agent of FIG. 3A, and FIG. 3C contains a flow diagram outlining steps performed in a subsequent active damage detection process for use in an inference process of the ADS-DRL agent of FIG. 3A.

FIG. 4 schematically represents an example of how a human operator is able to adjust a camera to validate the existence of an identified damage.

FIG. 5 contains a sample image of the steel surface with cracks and noisy background.

FIG. 6 depicts a comparison between images captured from field inspections and images rendered from a simulation environment. The images on the top row are from a field inspection, and those on the bottom row are images rendered in the simulation environment.

FIG. 7A schematically represents a visualization of candidate viewpoints and a current viewpoint at each time step, and FIG. 7B schematically represents the discretization of camera movements within an interactive environment. The camera is able to move transitionally in the x-y plane. At each time step, the ADS-DRL agent selects the next viewpoint to visit based on the received RGB image and historical information.

FIG. 8A depicts a single RGB frame, FIG. 8B depicts a ground truth crack mask, and FIG. 8C depicts a manually-cleaned prediction mask of FIG. 8A from the segmentation network. Although the prediction mask in FIG. 8C has been manually cleaned, the mIoU score of FIG. 8C is 85%, which falls below 100%.

FIG. 9A plots test mIoU of the fused mask generated by different inspection methods, FIG. 9B plots the average number of time steps taken by different methods to handle a frame with uncertain damage, and FIG. 9C plots episode reward signals of different configurations of active damage detection for the ADS-DRL agent. The Performance of different configurations of the ADS-DRL agent as the training iterations increased. The mIoU score of human baseline was 0.8402.

FIG. 10 is a graph plotting a detailed breakdown of the total inspection time of a multi-views ADS-DRL agent using various frame overlap ratios.

FIG. 11 contains images from an example episode of the ADS-DRL agent selecting viewpoints and fusing information to improve the prediction. The solid bounding boxes identify a crack, and the dashed bounding boxes identify a scratch that was falsely detected as a crack. From left to right, the fused mask is updated. While scratches were falsely detected as cracks in the initial mask Mₜ₌₁, they were corrected and completely disappeared in the final fused mask Mₜ₌₄. It should be noted that the fused masks are zoomed and fixed with respect to the initial observation Iₜ₌₁.

FIG. 12 contains images comparing predictions from raster scanning and predictions from the ADS-DRL agent.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s) depicted in the drawings, and identifies certain but not all alternatives of the embodiment(s). As nonlimiting examples, the invention encompasses additional or alternative embodiments in which one or more features or aspects described as part of a particular embodiment could be eliminated, and also encompasses additional or alternative embodiments that combine two or more features or aspects described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The present application discloses methods and systems that integrate the concept of active perception into robotic inspection systems that utilize one or more robots (robotic agents) that are adapted to perform inspections of surfaces of civil infrastructures, as nonlimiting examples, buildings, tunnels, nuclear facilities, oil and gas facilities, and bridges. The active damage detection may involve one or more of real-time active data collection, analysis, feedback, and/or control, allowing for immediate adjustments and validation of the uncertain damage within a field that has been inspected by a sensor, for example, within a field of view of a camera. Embodiments of the methods and systems have been implemented using a deep reinforcement learning (DRL) framework and evaluated through a case study focusing on the inspection of an underwater nuclear reactor to demonstrate the efficacy and advantages of active damage detection in robotic inspection systems. The findings showed that active data collection offers enhanced adaptability and reliability relative to previously known systems, enabling effective handling of uncertainties during inspection processes.

The methods and systems can be used to facilitate the use of robotic agents for autonomous damage inspection. While considerable progress has been achieved by utilizing state-of-the-art computer vision approaches for damage detection, these approaches are typically insufficient for autonomous robotic inspection systems due to the uncertainties in data collection and data interpretation. To address this gap, the present application discloses a new artificial intelligence framework (“AI framework”) that makes it possible for robotic agents to select the best course of action for active damage detection (perception) and reduction of uncertainties. By doing so, the required information may be collected more efficiently for a better understanding of damage severity, which is preferably capable of leading to more reliable decision-making. Provided as a non-limiting example, the AI framework was evaluated for the autonomous assessment of cracks on metallic surfaces of an underwater nuclear reactor. Active perception exhibited a notable enhancement in the crack Intersection over Union (IoU) performance, yielding an increase of up to around 40% when compared to its raster scanning counterpart given a similar inspection time. Additionally, a method of using the AI framework was developed that included performing a rapid inspection capable of reducing the overall inspection time by more than two-fold while achieving around a 15% higher crack IoU than that of the dense raster scanning approach. Further areas of applicability will become apparent from the description provided herein.

Certain technical aspects of investigations leading to the present invention included the development of an active damage detection process by defining a task, referred to herein as active damage segmentation (ADS) task, where a robotic agent can move a camera (or other imaging device) within a three-dimensional (3D) environment to perform damage segmentation on a surface. The ADS task was formulated as a Partially Observable Markov Decision Process (POMDP) problem and employed DRL to learn the near-optimal policy for the ADS task and approximate its solution. To tackle the ADS task, an active damage detection agent (referred to herein as the ADS-DRL agent) was developed to select informative viewpoints and fuse obtained information with the intent of improving predictions. A robotic agent utilizing the ADS-DRL agent explicitly considers the spatial location of a damaged area of a surface, and registers and fuses the same damaged area from different viewpoints to improve the segmentation mask. An interactive photo-realistic 3D simulator based on computer graphics was then built to train the ADS-DRL agent. The ADS-DRL agent was shown to consistently outperform a passive visual system. Moreover, the learned behavior of the ADS-DRL agent led to much more efficient data collection compared with raster scanning.

Generally, the invention encompasses methods for detecting cracks in a surface by training a robotic agent to distinguish with a camera of the robotic agent whether features in the surface are cracks or scratches in the surface, and then inspecting the surface by performing the ADS task that distinguishes between cracks and scratches in the surface by adaptively selecting different viewpoints of the first feature by moving the camera, acquiring observations with the camera corresponding to the different viewpoints, and fusing information obtained from the observations at the different viewpoints.

The following outlines the definition of the ADS task, its mathematical formulation, and the description of the ADS-DRL agent.

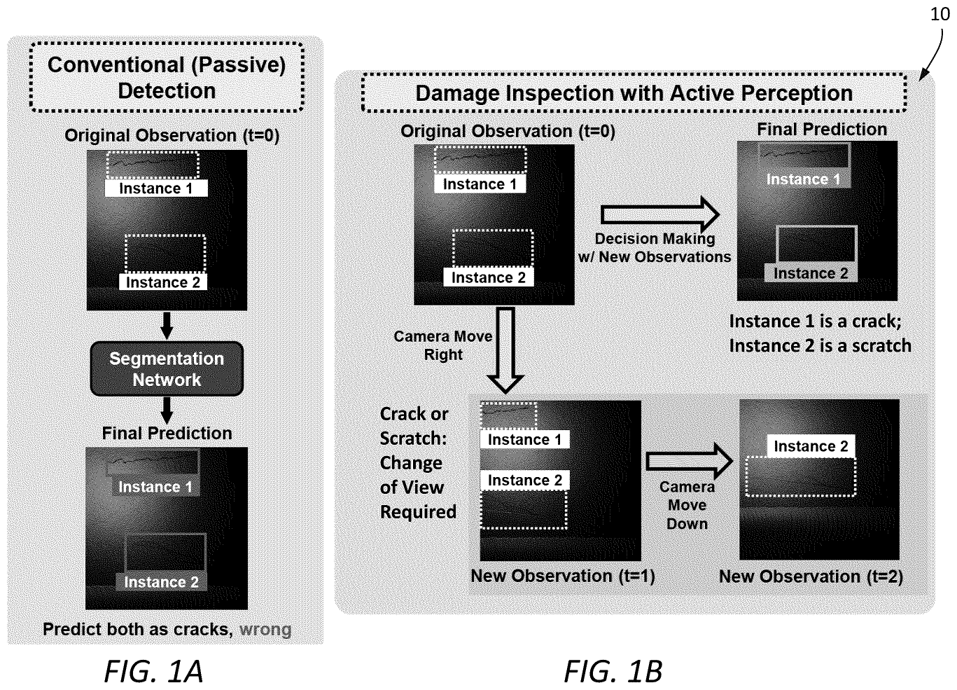

FIGS. 1A and 1B represent an active damage detection system 10 and method (FIG. 1B) in comparison with commonly-used passive damage detection methods (FIG. 1A). In the active damage detection system 10 and method, if there is uncertainty about whether a surface feature observed in a frame captured by a sensor (such as a camera) is actual surface damage, for example, due to poor lighting conditions, the robotic agent can decide to move around and gather additional information by adaptively selecting different viewpoints of the surface feature giving rise to the uncertain damage information, for example, by moving the robotic agent or at least moving the camera. In this way, the robotic agent tries to actively increase its confidence about the existence or absence of damage in a surface under inspection. To perform the ADS task, the robotic agent performs a sequence of actions to inspect the designated region so that the damage is correctly identified while false positives (i.e., non-damage predicted as damage) and false negatives (i.e., undetected damage) are minimized. The underlying principle is rooted in the concept that as the robotic agent proceeds through its sequence of actions, it gathers more information to gradually increase its belief about the existence or absence of damage, leading to robust decision-making at the end of the inspection. Notably, the robotic agent's actions are not predetermined but rather adaptive, allowing it to dynamically chart its course based on the information it gathers during the process. By adopting this approach, the robotic agent engages in active information acquisition, selectively seeking out viewpoints that contain more useful information. This dynamic interaction is crucial in enabling the robotic agent to have a holistic understanding of the inspection area and enhances the accuracy of its detection outcomes.

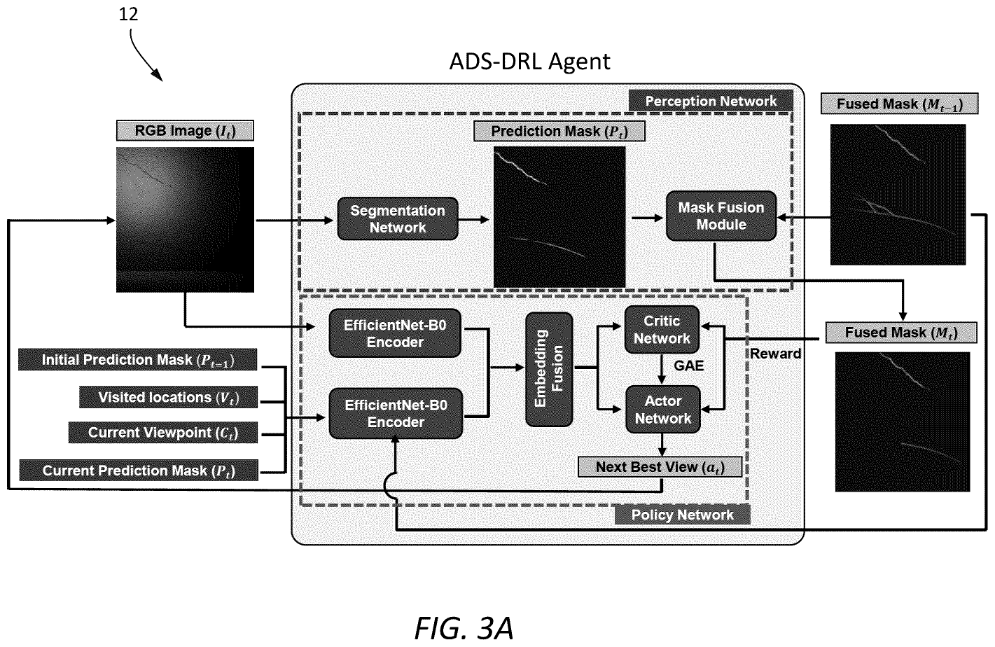

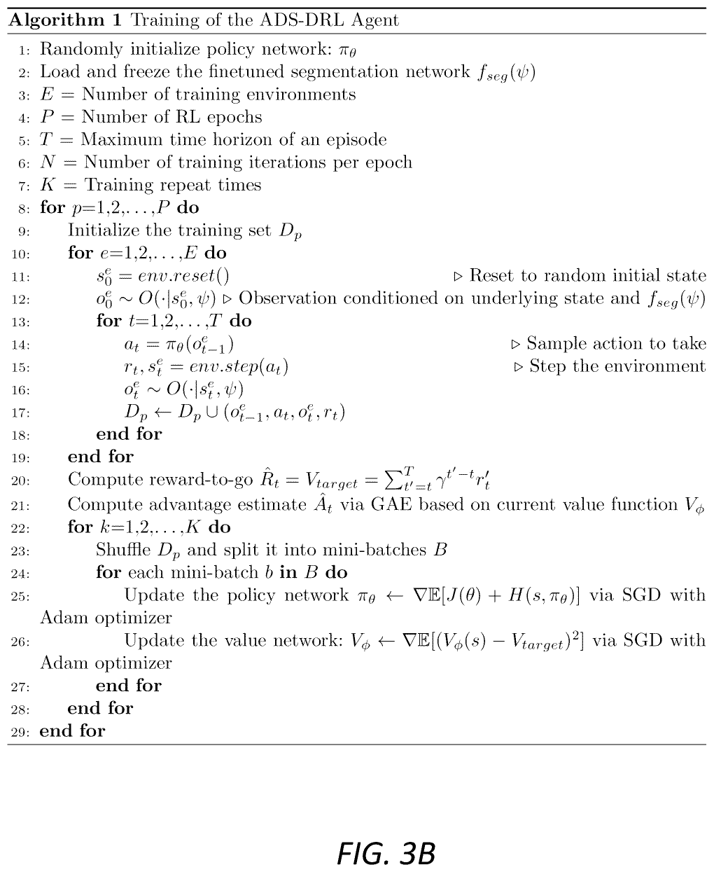

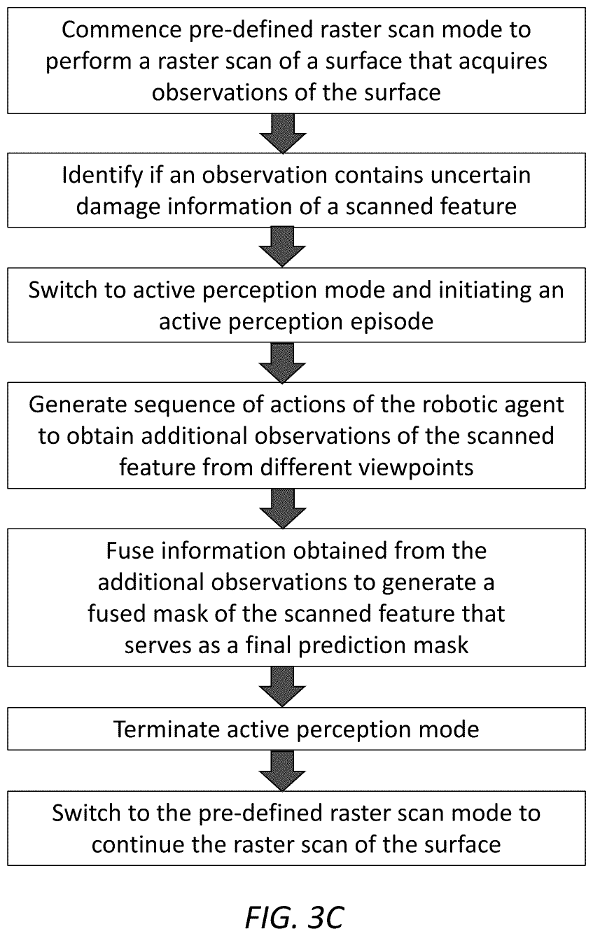

While the ADS task was developed as a general framework that can be applied to any inspection task, it was applied to the crack detection of metallic surfaces of nuclear facilities in the investigations leading to the present invention. To cover an entire metallic surface, FIG. 3C represents the robotic agent as commencing a pre-defined raster scan mode with a camera to perform a raster scan of the surface and acquire observations of the surface. The raster scan was performed with a low overlap ratio between frames taken at each time step to ensure that every area of the surface was inspected. When an observation within a frame contained uncertain damage, the robotic agent switched to active perception mode. In the investigations, a frame was deemed to contain uncertain damage if the count of pixels with softmax scores above 0.6 exceeded two hundred in the predicted mask of the current frame. This was based on observations that instances of less severe damage, such as scratches, are frequently misclassified as more severe damage, such as cracks, with high softmax scores. After the activation of the active perception mode, the frame that triggered the mode became the initial frame Iₜ₌₁ for the interactive process of active perception. The goal was to propose a sequence of actions (viewpoints) and acquire useful new information to enhance the initial prediction mask Mₜ₌₁ of the first frame Iₜ₌₁. By fusing information from new viewpoints, a fused mask M_{t=T} was generated at the final time step, which served as the final prediction mask for the first frame Iₜ₌₁. The active perception loop was terminated once the robotic agent chose a Terminate action or the time horizon (i.e., the maximum number of interactions that a robotic agent was allowed to take in a single episode) allotted for the episode was exceeded. The robotic agent resumed the raster scanning pattern after the termination of the active perception mode until it had encountered another frame that activated active perception, i.e., a frame whose count of pixels with softmax scores above 0.6 exceeded two hundred.

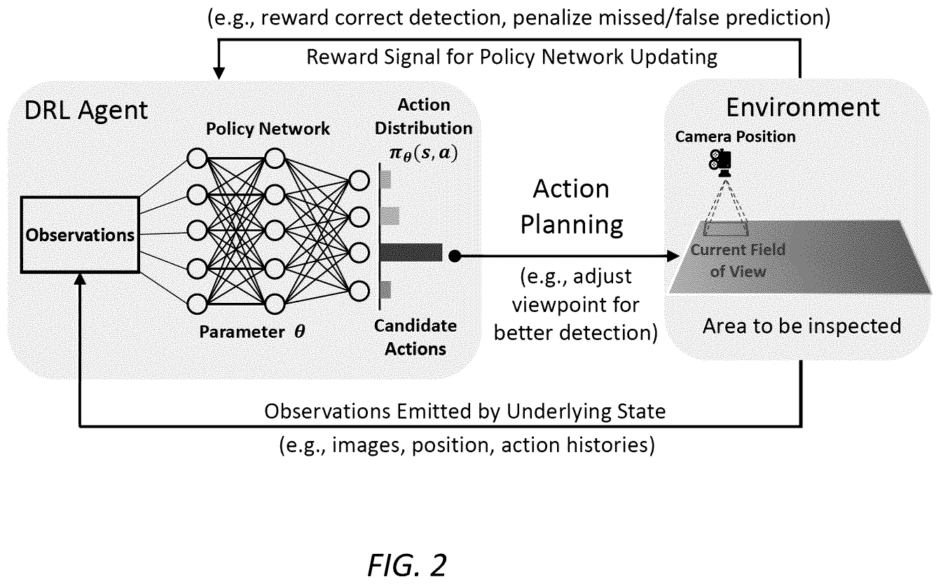

To finish the ADS task, the active damage detection (ADS-DRL) agent 12 makes a sequence of actions based on its observations, which is essentially a sequential control problem. The robotic agent follows a policy provided by the policy network to take an optimal sequence of observations and actions that are sufficient to finish the inspection task. The investigations used the deep reinforcement learning (DRL) framework to train the policy network. During the training, the robotic agent received an observation, and then fed the observation through the policy network modeled as a deep neural network (DNN) to produce an action to be taken by the robotic agent, such as movement of the robotic agent or at least movement of its camera. Then, the robotic agent acted within the environment using the prescribed action and received a reward signal from the environment (typically a scalar value), telling the policy network how good the action was. The robotic agent received a higher reward for progressing toward an objective. For example, in the investigations, the objective was to accurately segment cracks without false positives. A reward signal was used to supervise the training of the policy network. Along with the reward, the robotic agent also received a new observation from the environment based on the action taken (i.e., additional observations from additional viewpoints). Then, the sequence of observation, action, and reward signal was repeated as a loop until a termination action was chosen or the loop ran out of time in one episode. This loop can be understood as training a system through a series of trial-and-error attempts, where the system is rewarded for achieving increasingly accurate segmentation results. The overall framework is shown in FIG. 2.

Put in a more rigorous mathematical form, the active damage segmentation problem can be formulated as a Markov Decision Process (MDP), which provides a mathematical model for decision-making when the outcomes are based on stochastic processes. In MDP, the current state and its corresponding expected reward depend only on the previous state and action. MDP is a powerful framework for decision making under uncertainty, but a limitation of MDP is the assumption that the robotic agent always knows the current state with certainty. This might not be a valid assumption for some applications, particularly in information gathering tasks where, instead of the true state of the whole environment, the agent only has access to observations (e.g., an image that has a limited field of view). These observations could be noisy, incomplete, or even contradictory to previous observations. It should be noted that the goal of the robotic agent is to take actions (e.g., looking at a region from different viewpoints) for reliable information gathering while dealing with uncertainties. To account for these limitations, the ADS task was formulated as POMDP.

A discrete-time POMDP is defined as a tuple {S, A, T, R, Ω, O}, where S={s₁, s₂, . . . , sₙ} is a set of partially observable states of the environment, A={a₁, a₂, . . . , aₘ} is a set of actions available to the robotic agent, T is a set of conditional transition probabilities from state s to state s′: P(s′|s, a), R: S×A→ [symbol] is the reward function, Ω={o₁, o₂, . . . , oₖ} is a set of observations, and O is a set of observation probabilities O(o|s) conditioned on the reached state and the action taken. At each time step, the environment is in some unknown state s∈S. The robotic agent chooses an action a∈A, which causes the environment to transit to state s′∈S with probability T (s′|s, a). At the same time, the robotic agent receives an observation o∈Ω that depends on the new state s′ with probability O(o|s′, a). Finally, the robotic agent receives a reward signal r∈R(s, a). This loop repeats until it terminates in an episodic setup. Let T be the trajectory that contains a sequence of (oₜ, aₜ, rₜ), where aₜ˜π(⋅|oₜ), Sₜ₊₁˜T(Sₜ, aₜ), and π is the current policy. Given a discount factor γ, an optimal policy π* can be expressed as Eq. 1 below:

$${π}^{*} = arg {max}_{π} {𝔼}_{τ ∼ π} [ {R}_{T} ] , where {R}_{T} = {\sum }_{t = 1}^{T} {γ}^{t - 1} {r}_{t} \qquad ( 1 )$$

The objective is to find a policy π that maximizes the discounted accumulative return R_{T} over an episode. One technique to find such a policy π is Proximal Policy Optimization (PPO), which is an on-policy algorithm that belongs to the gradient-policy family and can be used to calculate a gradient of the policy network. The advantage Aₜ function used in the PPO is estimated through Generalized Advantage Estimator (GAE). The parameter θ can be updated by maximizing the following surrogate objective function (Eq. 2):

$$J ( θ ) = 𝔼 [ min ( {ratio}_{L} ( θ ) {\hat{A}}_{t} , clip ( {ratio}_{t} ( θ ) , 1 - ϵ , 1 + ϵ ) {\hat{A}}_{t} ) ] \qquad ( 2 )$$

$$where$$

$${ratio}_{t} ( θ ) = {π}_{θ}^{cur} ( {a}_{t} \vert {o}_{t} ) / {π}_{θ}^{old} ( {a}_{t} \vert {o}_{t} )$$

is the ratio between the probability of the action aₜ under the current policy and the policy used to collect the rollout.

When applying the PPO algorithm on a deep neural network (DNN) with shared parameters between the actor network and critic network (FIG. 3A), the final objective function (Eq. 3 below) is augmented with the value estimation error term and the entropy term. The coefficient terms C₁ and C₂ are defined by the user to stabilize the DRL training process.

$${J}^{PPO} ( θ , ϕ ) = 𝔼 [ J ( θ ) - {{c}_{1} ( {V}_{ϕ} ( s ) - {V}_{target} )}^{2} + {c}_{2} H ( s , {π}_{θ} ) ] \qquad ( 3 )$$

The value estimated error term is added so that the critic network can accurately estimate the value function V (sₜ), and the entropy term is to encourage the exploration of the robotic agent during training. In the investigations, the expected return (reward-to-go)

$$Gt = {V}_{target} = {\sum }_{k = t}^{T} {γ}^{k - t} {r}_{k}$$

is used as the fitting target V_{target}, and the entropy is calculated by

$$H ( s , {π}_{θ} ) = - {\sum }_{a ∈ A} π ( a \vert {s}_{t} ) log π ( a \vert {s}_{t} ) .$$

As previously stated, the ADS task was performed by the ADS-DRL agent formulated as a POMDP, where the robotic agent cannot directly observe the underlying state s∈S but can observe the observations emitted from the underlying state o˜O(⋅|s) (i.e., images). For example, the robotic agent could not observe some visual features that can help distinguish cracks from scratch under bad lighting conditions. The observation o˜O(⋅|s, ψ) represents what the robotic agent perceives, and it is conditioned on both the underlying state s and the parameter of the segmentation network ψ (i.e., weights of the deep neural network). The observation contains current RGB images Iₜ (frame) of size N×N, the location of the current field of view Cₜ∈{0,1}^{3N×3N}, visited locations Vₜ∈{0, 1}^{3N×3N}, and fused crack segmentation mask from previous timestep Mₜ₋₁∈[0, 1]^{N×N} with N=448. The dimensions of Cₜ and Vₜ were set to 3N×3N to ensure that they encompassed the maximum boundary where every frame within the boundary overlaps with the initial frame Iₜ₌₁. Each pixel in Cₜ is 0 or 1, indicating whether the current viewpoint covers the corresponding area or not, and each pixel in Vₜ indicated if the corresponding area had been visited. The centers of Cₜ, Vₜ, and Mₜ shared the same global coordinates as the center of Iₜ₌₁.

The continuous viewpoint locations were discretized into discrete locations, as discussed below. The robotic agent was able to visit one of the viewpoints at each time step. If the robotic agent concluded that it had identified a sufficient number of viewpoints to differentiate uncertain damage shown in the initial frame, it may choose to terminate the episode early by selecting the Terminate action. However, if the robotic agent terminates early with incorrect predictions, it will incur a significant penalty. Therefore, the entire action space A comprises a set of 48 discrete viewpoints around the current viewpoint and an additional Terminate action.

In training, the main reward was related to the mIoU improvement of the final segmentation mask M_{t=T} compared with the initial prediction mask Pₜ₌₁. To obtain a denser reward, a reward signal was given at each time step by computing the mIoU difference of the current fused segmentation mask Mₜ with the segmentation mask from the previous timestep Mₜ₌₁. To encourage efficient active inspection without unnecessary selection of viewpoints, each viewpoint selection action was penalized with a small negative reward signal costₐₜ. To prevent the robotic agent from exploring scenes for an unnecessarily long time, the robotic agent was rewarded with a positive reward signal +α upon selecting the Terminate action if the final segmentation mask had significantly fewer false positive predictions (pixels) compared with the initial prediction mask (i.e., FP(Mₜ)≤β*FP(Mₜ₌₁)) and, at the same time, achieving a recall value higher than a certain threshold η. If the above-mentioned condition was not satisfied when the episode terminated, the robotic agent was given a negative reward signal −α. The horizon (maximum timestep allowed) of an episode was set to 20 in the investigations, meaning that the episode would terminate automatically after 20 timesteps if the Terminate action is never chosen within an episode.

The detailed reward rₜ was given as follows:

$${r}_{t} = \{ \begin{matrix}IoU ( {M}_{t} ) - IoU ( {M}_{t - 1} ) - {cost}_{{a}_{t}} , & if case 1 \\ + α , & if case 2 \\ - α , & otherwise\end{matrix} \qquad ( 4 )$$

where case 1 refers to scenarios where aₜ≠Terminate, and case 2 refers to scenarios where aₜ≠=Terminate, FP(Mₜ)≤β*FP(Mₜ₌₁), Recall(Mₜ)≥η, while all other cases fall into the otherwise case. The values of α, β, η, and costₐₜ were assigned as 0.5, 0.1, 0.9, and 0.01. The fused mask Mₜ averages the softmax score of the overlapping area between current prediction Pₜ and the previous fused mask Mₜ₋₁. The abovementioned reward setup was for a Multi-Views Policy described below. For a Single View Policy also described below, the reward is given as follows:

$${r}_{t} = \{ \begin{matrix}- {cost}_{{a}_{t}} , & if case 1 \\ IoU ( {M}_{t = T} ) - IoU ( {M}_{t = 1} ) + α , & if case 2 \\ IoU ( {M}_{t = T} ) - IoU ( {M}_{t = 1} ) - α , & otherwise\end{matrix} \qquad ( 5 )$$

For the single-view setup, the IoU reward was only given at the termination of the episode since the prediction mask was only updated at the end of the episode.

The detailed architecture of the ADS-DRL agent 12 is shown in FIG. 3A as comprising the aforementioned perception network (including the segmentation network and mask fusion module) and policy network as separate modules. The ADS-DRL agent 12 is spawned with an initial location and viewpoint of the robotic agent where uncertain damage is presented in the initial frame denoted by Iₜ₌₁. At each time step from t=1 to t=T, given an observed RGB image (frame) Iₜ, the perception network predicts a damage mask Pₜ, which may or may not be correct. Then the perception network takes an action at specified by the policy network 71e, based on the location of the current field of view Cₜ₌₁, the visited field of view Vₜ₌₁, current RGB image Iₜ₌₁, previous fused mask Mₜ₋₁, and the initial prediction Pₜ₌₁. The fused mask Mₜ₋₁ is defined as M_{t=T}=f_{agg}(Mₜ₋₁, Pₜ) where f_{agg} (⋅) is the mask fusion module shown in FIG. 3A. The final segmentation mask is the same as the fused mask at time step t.

The segmentation network f_{seg}(ψ) predicts the damage mask given an RGB image at each time step. The architecture of the segmentation network is based on U-Net++, with ResNet-101 pre-trained on ImageNet as the backbone and includes dense skip connections to enhance segmentation accuracy. The segmentation network of the ADS-DRL agent 12 is fine-tuned on an online crack dataset using transfer learning with pre-trained weight trained on ImageNet. The segmentation network is not trained using the generated simulation dataset because the neural network can easily achieve almost perfect accuracy on the training dataset. This level of over-fitting would prevent the policy network from learning any meaningful policies. During DRL training, the ADS-DRL agent 12 starts at random positions where the initial prediction contains more than 200 pixels whose softmax scores exceed a predefined threshold.

Each pixel in the mask output from the segmentation network has a softmax score ranging between 0 and 1. To better improve the final segmentation mask, the mask fusion module takes in both previous fused mask Mₜ₋₁ and current prediction mask Pₜ and outputs the fused mask Mₜ at timestep t. When performing the fusion, the mask fusion module obtained the intrinsic and extrinsic parameters of the pinhole camera model obtained previously from Houdini, and projected Pₜ onto Mₜ₋₁ using the projection matrix. It then fused the softmax in the overlapping area with a simple average function. More sophisticated functions, such as Bayesian update or even another neural network, could be utilized as an alternative fusion method.

The policy network π_{θ} was disentangled from the segmentation network so that the learned policy did not overfit to a specific segmentation model. The policy network received [Iₜ, Cₜ, Vₜ, Pₜ, Pt=1, Mₜ₋₁] as input, and outputs the probabilities over the action space A. There were four components

$${f}_{Encoder}^{img} , {f}_{Encoder}^{mask} , {f}_{Fusion} , {f}_{Actor - Critic}$$

in the policy network. At time step t, the RGB image Iₜ is fed into the image encoder

$${f}_{Encoder}^{img}$$

that outputs a feature map

$${x}_{img}^{t} .$$

Similarly, [Ct, Vt, Pₜ, Pₜ=1, Mₜ₋₁] are concatenated together and fed into

$${f}_{Encoder}^{mask}$$

that outputs a feature map

$${x}_{fusion}^{t}$$

These two feature maps are then fed into the embedding fusion module f_{Fusion} that consists of convolution layers followed by a fully connected layer. Outputs of the embedding fusion module

$${x}_{mask}^{t} .$$

are then fed into the actor-critic network factor-critic, where each of the two heads contains a Gated Recurrent Unit (GRU) and two fully connected layers. The output of the critic's head is the aforementioned value estimation, and the outputs of the actor network are the probabilities over action space A.

The policy network is trained using the PPO algorithm. The policy network first interacts with the simulation environment to obtain the sequence of observations, actions, and reward signals. Then, the reward signal is used to evaluate the quality of the sequences and calculate a gradient of the policy network using the PPO algorithm based on the observations, actions, and reward signals. The parameters of the policy network are adjusted based on the calculated gradient, such that the adjusted policy network is able to learn to output better action sequences after the parameter adjustment. More sequences of observations, actions, and reward signals are collected based on the updated policy network, the gradient is calculate, and the parameters of the policy network are adjust again. Over many rounds of training and updates, the robotic agent is able learn to perform crack segmentation intelligently by carefully planning its viewpoints and actions.

At the beginning of every epoch, the perception network of the ADS-DRL agent 12 was trained by sampling random starting positions from positions where the initial prediction contains more than 200 pixels whose softmax scores were above a predefined threshold. The weight of the fine-tuned segmentation network was frozen during the DRL training. The value of the discount factor γ was set to 0.99, and the exponential weight discount factor in GAE was set to 0.95. The user-defined coefficient C₁ and C₂ were set to 0.5 and 0.1, respectively. During each training episode, the maximum number of actions that the perception network could take was set to 20. The perception network was trained for 20,000 iterations, corresponding to approximately 3.6 million steps of experience. Details of the training process are presented in FIG. 3B, which contains an algorithm used to train the perception network of the ADS-DRL agent 12 represented in FIG. 3A.

Following training, the ADS-DRL agent 12 is able to perform an inference process represented by a flow diagram in FIG. 3C to perform active damage detection in a surface by adaptively selecting different viewpoints of one or more surface features present in the surface. The inference process commences with a pre-defined raster scan mode with a camera (or other sensor) to perform a raster scan of the surface that acquires observations of the surface, and then identifying if an observation of a surface feature acquired at a viewpoint contains uncertain damage information. If so, the process switches to an active perception mode to initiate an active perception episode. A sequence of actions of the robotic agent is generated to move the camera and acquire at least one additional observation of the surface feature from at least one different viewpoint, and then information obtained from the additional observation is fused to generate a fused mask of the surface feature that serves as a final prediction mask. According to a preferred aspect, the sequence of actions can be generated by passing an observation through a trained perception module that performs the active perception mode and produces an initial segmentation softmax map, after which a second viewpoint is determined for a second observation of the surface feature from the initial segmentation softmax map. The first and second observations are acquired so as to have overlapping regions, and the fusing step comprises fusing the softmax scores from the overlapping regions of the first and second observations, and then inputting the fused softmax scores to the policy network to generate a fused segmentation softmax map from which can be determined another viewpoint for acquiring another observation of the surface feature. The generating and fusing steps can be repeated as a loop until the robotic agent terminates the loop based on training of the policy network. Following the fusing step, the active perception mode can be terminated and the operation of the robotic agent switched to the pre-defined raster scan mode to continue the raster scan of the surface.

In the investigations, the POMDP framework was utilized to model active perception, with the observation space defined by RGB images, the location of the current field of view, visited locations, and the fused crack mask. Ideally, solving POMDP problems would involve considering the entire trajectory and observation history. However, explicitly considering the entire observation history (i.e., taking the whole history as input observations) would be computationally intractable and add difficulties to generalization. Given that the observation data consists of high-dimensional images, feeding the entire history (up to 20 images) into the network would necessitate optimization over a very large neural network, making it difficult to train. Additionally, not all details of the image history are relevant to the task.

The active damage detection system 10 and method balanced current observations with necessary historical information. The robotic agent maintained a map of visited viewpoints and a fused mask, allowing it to know where it had been and what information had been integrated into the crack mask. It also had access to the initial crack mask, serving as a reference for areas needing further inspection. Additionally, the policy network included a GRU, which encoded historical observations. With proper training, the GRU unit learned to encode and retain relevant historical information, providing it to the robotic agent at each current time step.

These design choices enabled the active damage detection system 10 and method to effectively balance the need for historical context with computational feasibility. Optimal solutions to POMDPs typically involve policies that consider probability distributions over possible states and make decisions based on these distributions. While the adopted policy simplified the decision-making process, exploring more general policies that incorporate the entire history of observations could provide further improvements.

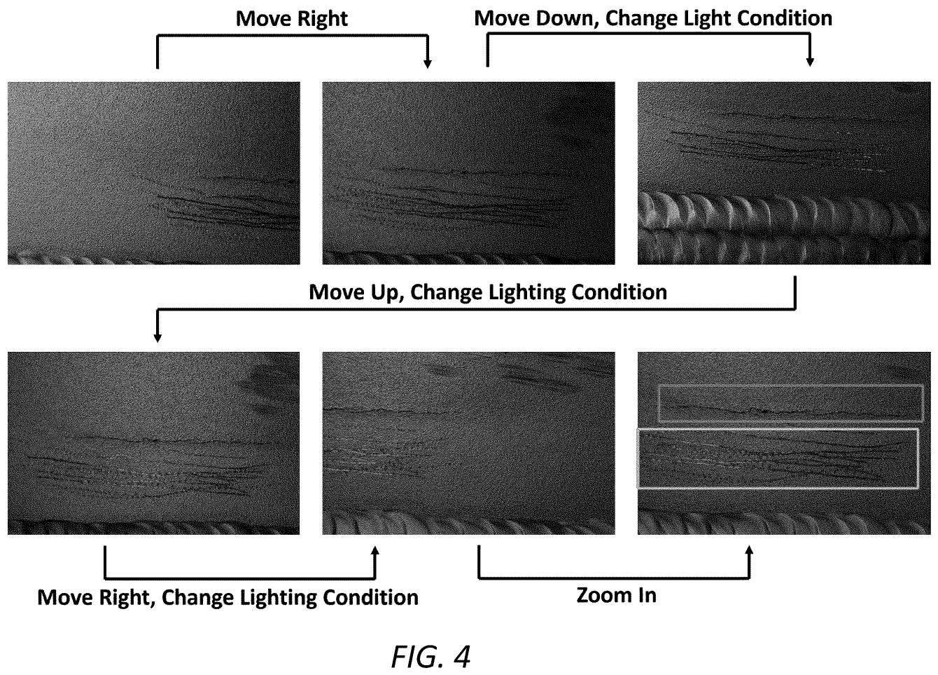

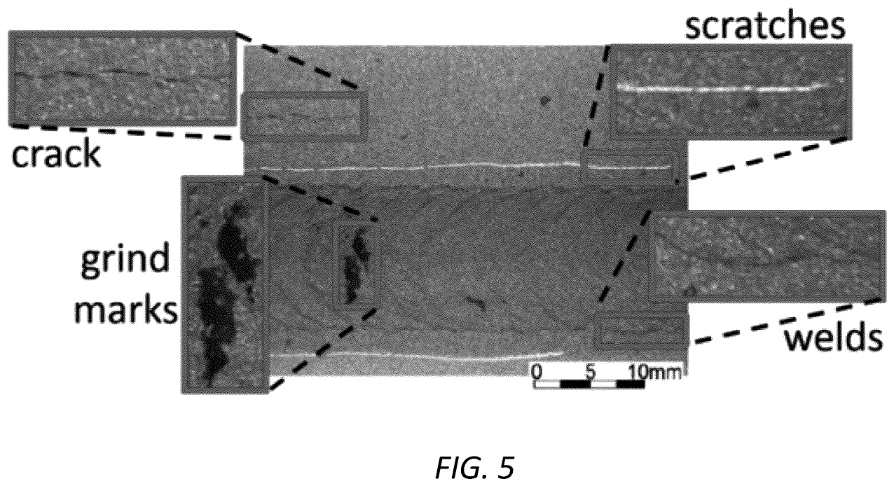

The active damage detection system 10 and method was evaluated for the autonomous assessment of cracks on metallic surfaces. In order to train and evaluate the active damage detection system 10, a 3D environment was needed to execute actions whose outcomes were provided as datasets to train the perception network. The simulation environment was intended to mimic the environment of underwater nuclear reactor surface inspection, exemplified by a sample image in FIG. 5 that shows a surface of a steel specimen having surface cracks within a noisy background that includes a weld and scratches. The metallic specimens to be inspected were located inside a test tank filled with water, where a robotic arm of a robotic agent maneuvered a camera, pointing perpendicular to the surface, to record videos of the entire surface in a raster pattern. Throughout the inspection process, a human operator sat at a computer and oversaw the condition of the metallic specimens for any indications of damage, particularly cracks. In the event that cracks or questionable features manifested within the current camera's field of view, the operator intervened by manually adjusting the camera's position to validate the existence of the damage (FIG. 4). The investigations were intended to build an AI system capable of emulating camera manipulation and damage validation skills like a human operator. To simplify the question, the motion planning and controlling of the robotic arm are not included in the investigations. The emphasis was directed towards high-level control, specifically the selection of viewpoints. Following the determination of the viewpoint (waypoint) to be visited at each time step, diverse path-planning algorithms, such as probabilistic roadmap methods, can be employed to generate the motion path of the robotic arm.

To minimize potential gaps between simulation and actual scenarios, a simulation environment was devised to accurately model the physics of an underwater environment to ensure realistic interactions (e.g., light reflections). Ideally, the simulation environment also accurately reproduced the visual appearances of the steel specimens in field inspection and how the appearances of the specimens change when the viewpoint changes. An intuitive solution is to acquire real-world data by conducting 3D scanning of a scene and manually annotating the ground truth. However, this approach can be challenging since both 3D scene reconstruction and manual labeling were arduous and labor-intensive tasks. An alternative approach would be to use simulation data and build digital twins of the scenes with computer graphic techniques. Previous studies have shown that neural networks trained on photo-realistic simulation data (e.g., RGB images) generated by computer graphic techniques can perform reasonably well on real data. In addition, the ground truth mask of the simulation data can also be generated automatically, saving a significant amount of time and effort that would otherwise be required for manual annotation.

Therefore, computer graphic techniques are employed in the investigations to generate a vast number of images and data that would benefit the training of the ADS-DRL agent 12. To accurately reconstruct the metallic test specimens that have been inspected in real-life and mimic the light reflections, the videos recorded by the robotic arm in field inspections were used to reconstruct 3D models of those test specimens in a computer graphic tool commercially available from SideFX Software under the name HOUDINI®. Each steel specimen used in the simulation environment had weld crowns and different numbers of grinding marks, scratches, and cracks on the surface that closely resembled what are normally found on internal nuclear power plant components, such as illustrated in FIG. 5. Each 3D model was put into different 3D scenes where various light sources were added to simulate light conditions that exist in field inspections. It should be noted that, similar to a field inspection, the light conditions change as the robotic agent moves around in the 3D scenes.

In the investigations, different field inspection videos were analyzed and thirty different 3D scenes were generated. Each scene contained a unique 3D model representing diverse test specimens. Images associated with camera poses were rendered from these scenes to create a dataset for the training of the ADS-DRL agent 12. For each scene, the surface area to be inspected was 219 mm×153 mm, and the width of the cracks varied from 0.1 to 0.5 mm. Each rendered image was associated with annotations of scratch and crack, which could be extracted automatically from the scene. Out of the thirty scenes, fifteen were used for training the ADS-DRL agent 12, and the remainder were used for testing.

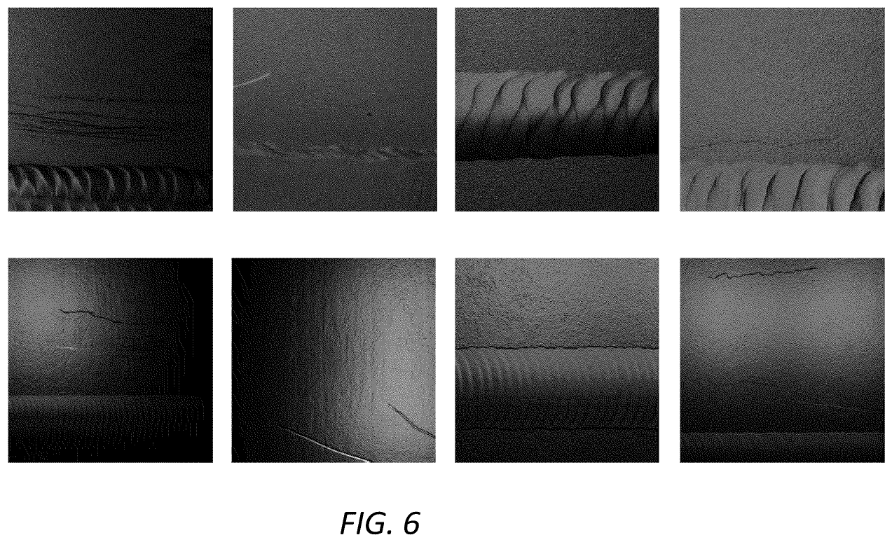

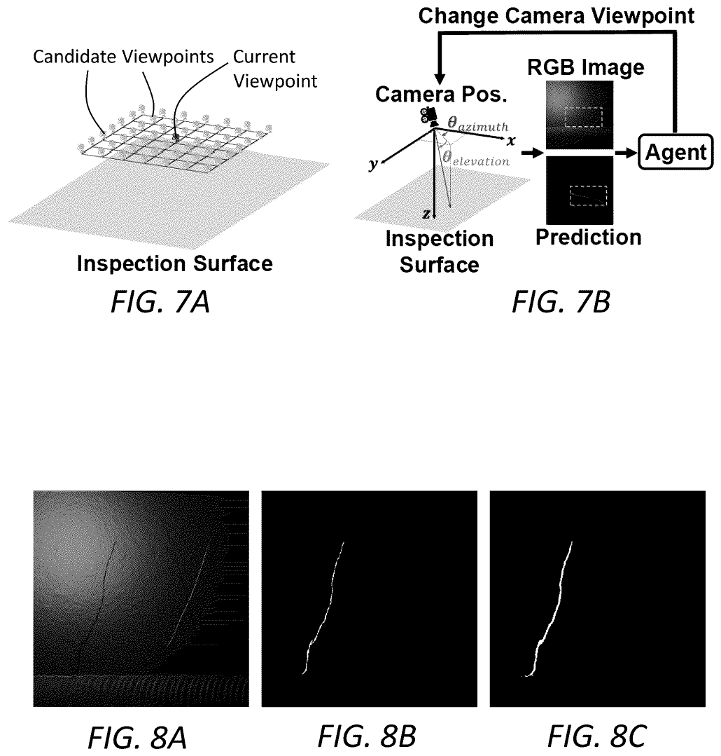

FIG. 6 shows examples of the images captured during the on-site inspection and rendered by computer graphics. In the investigations, a dataset was constructed using pre-rendered images, and these images were accessed during training to avoid online rendering and speed up the interaction process during training. The movement of the camera was continuous, and it was therefore not possible to store all images for all continuous locations. Therefore, the viewpoints were discretized so that the viewpoints are 8 cm apart in the x or y direction of the x-y plane of the surface being imaged. The camera was capable of moving up, down, left, and right in the x-y plane as shown in FIG. 7B. For each viewpoint, the azimuth angle of the camera orientation was between [0,360° ] and the elevation angle was between [30°,90° ], where the angles were further discretized into 300 increments. To simplify the problem, only cases in which cameras were pointed perpendicular to the inspected surface were considered in the investigations. Therefore, as shown in FIG. 7A, the action space is represented as comprising a set of forty-eight “candidate” viewpoints surrounding a “current” viewpoint, where the ADS-DRL agent 12 was able to select any one of the viewpoints at each time step. Upon taking an action, the corresponding image from the dataset was queried by the robotic agent. More complex actions, such as non-perpendicular angles along with geometric transformation of the images, are foreseeable.

In the investigations, the performance of the ADS-DRL agent 12 is evaluated with a crack segmentation task in which the mIoU score of the predicted mask, the IoU score of the crack, the number of false positive crack instances, and the inspection time were reported. If the number of connected pixels with softmax scores higher than a certain threshold (default to 0.5) was more than 1000, then a surface feature on the prediction mask was determined as a crack instance. To further measure the performance of the robotic agent on crack segmentation tasks, the definition of mIoU and crack IoU were defined as:

$$mIoU = \frac{1}{{N}_{class}} {\sum }_{i = 1}^{{n}_{close}} \frac{{TP}_{i}}{{TP}_{i} + {FP}_{i} + {FN}_{i}} \qquad ( 6 )$$

$$IoU = \frac{{TP}_{crack}}{{TP}_{crack} + {FP}_{crack} + {FN}_{crack}} \qquad ( 7 )$$

where N_{class} is the number of classes (two in the investigations), T Pᵢ, FPᵢ, and FNᵢ are the total number of true positive, false positive, and false negative pixels for class i in the final segmentation mask for the entire inspection surface area in each scene. Furthermore, the performances of different configurations of the ADS-DRL agent 12 outlined below were compared with several baselines to show the merits of the process.

Single View Random Policy: Whenever there was uncertain damage in the prediction of the current frame Pₜ₌₁, the robotic agent uniformly selects a random viewpoint among the 7×7 viewpoints (see FIG. 7A) around the current viewpoint. The prediction of the overlapping area between Pₜ₌₁ and Pₜ₌₂ is overwritten by the prediction from Pₜ₌₂. After that, the robotic agent resumes raster scanning. This baseline was considered the lower bound of the ADS task.

Multi-Views Random Policy: The setup was similar to Single View Random Policy except that the robotic agent acts for multiple time steps and fuses the prediction Pₜ₌₁ from the new viewpoint to the initial prediction Pₜ₌₁. The robotic agent stops selecting new viewpoints and resumes raster scanning when it reaches the time horizon.

Pure Raster without Fusion Policy: The robotic agent uses a non-overlap raster scanning pattern to inspect the entire surface area.

Pure Raster with Fusion Policy: The robotic agent uses an overlap raster scanning pattern to inspect the entire surface area. The predictions in the overlapping area are fused. In the investigations, five different overlap ratios were used.

Single View ADS-DRL Policy: The ADS-DRL agent 12 is activated whenever there is uncertain damage in the prediction of the current frame Pₜ₌₁. At each time step, the robotic agent receives an observation and chooses the next viewpoint to visit, where the next viewpoint is prescribed by the learned policy network. Upon termination, the prediction of the overlapping area between Pₜ₌₁ and P_{t=T} is overwritten by the prediction from P_{t=T}. It should be noted that the overwrite step only happens when the episode terminates and there is no fusion between t=1 and t=T−1.

Multi-Views ADS-DRL Policy: The ADS-DRL agent 12 is activated for active crack inspection whenever there is uncertain damage in the prediction of the current frame Pₜ₌₁. The setup is similar to the Multi-Views Random Policy, except that the viewpoint chosen at each timestep is prescribed by the learned policy network instead of chosen randomly.

Human Baseline It is important to note that the crack IoU score cannot reach 100% because the cracks are too thin. The human baseline is considered as the upper bound of the ADS task. To calculate such an upper bound, the crack masks are manually curated to remove false positive crack pixels that are not in close vicinity of the actual crack. As shown in FIGS. 8A through 8C, the prediction from the segmentation network closely matches the shape of the ground truth crack with a few extra false positive crack pixels around the edges of the crack (i.e., predicted crack is thicker compared to ground truth), but the mIoU score is still below 100%. Therefore, given the limitation of the segmentation network, the human baseline is considered as the upper bound of the ADS task.

Table. 1 demonstrates the performance of the different configurations of the ADS-DRL agent 12 in the test scenes.

TABLE 1
Quantitative Performance of Pure Raster Scanning, Random Policies, and Different Configurations
of ADS-DRL Agents on ADS tasks. A series of 3 independent trials with different random
seeds are run for each experiment. Mean (μ) and standard deviations (σ) are provided
except for pure raster scanning, where the results are deterministic.

| | Frames | Crack IoU | mIoU | F1 Score | FP | Time (Sec.) | |
|---|---|---|---|---|---|---|---|
| Methods | Overlap | μ(σ) | μ(σ) | μ(σ) | Cracks | μ(σ) | |
| Pure Raster | None | 0.2629 | 0.6315 | 0.4164 | 8 | 23.2 | |
| Scanning | 25% | 0.3648 | 0.6824 | 0.5346 | 14 | 31.8 | |
| | 45% | 0.4026 | 0.7013 | 0.5741 | 14 | 47.0 | |
| | 63% | 0.4618 | 0.7309 | 0.6318 | 10 | 63.7 | |
| | 81% | 0.4611 | 0.7306 | 0.6312 | 13 | 101.9 | |
| Raster + Random | None | 0.3122 (0.07) | 0.6561 (0.03) | 0.4759 (0.06) | 10 | 26.4 | |
| (Single View) | 23% | 0.3143 (0.08) | 0.6572 (0.04) | 0 4782 (0.05) | 15 | 37.6 | |
| | 45% | 0.3969 (0.05) | 0.6985 (0.03) | 0.5683 (0.04) | 14 | 58.6 | |
| | 63% | 0.4686 (0.03) | 0.7343 (0.02) | 0.6382 (0.04) | 14 | 87.9 | |
| | 81% | 0.4728 (0.03) | 0.7364 (0.03) | 0.6421 (0.03) | 12 | 134.7 | |
| Raster + Random | None | 0.3390 (0.04) | 0.6700 (0.03) | 0.5074 (0.04) | 8 | 32.5 | |
| (Multi-views) | 25% | 0.3248 (0.04) | 0.6624 (0.03) | 0.4910 (0.04) | 5 | 57.0 | |
| (T = 5) | 45% | 0.3904 (0.04) | 0.6952 (0.03) | 0.5616 (0.03) | 5 | 93.1 | |
| | 63% | 0.4291 (0.03) | 0.7146 (0.02) | 0.6005 (0.02) | 4 | 145.3 | |
| | 81% | 0.4523 (0.03) | 0.7262 (0.02) | 0.6229 (0.02) | 4 | 187.0 | |
| ADS-DRL Agent | None | 0.4210 (0.04) | 0.7110 (0.02) | 0.5935 (0.04) | 0 | 30.4 | (2.5) |
| (Single View) | 25% | 0.5230 (0.04) | 0.7615 (0.02) | 0.6868 (0.04) | 0 | 44.9 | (3.5) |
| | 45% | 0.5257 (0.03) | 0.7629 (0.02) | 0.6891 (0.03) | 0 | 66.1 | (4.3) |
| | 63% | 0.5763 (0.02) | 0.7882 (0.01) | 0.7312 (0.02) | 0 | 103.3 | (6.8) |
| | 81% | 0.5770 (0.02) | 0.7885 (0.01) | 0.7317 (0.02) | 0 | 135.8 | (7.7) |
| ADS-DRL Agent | None | 0.4450 (0.04) | 0.7230 (0.02) | 0.6135 (0.04) | 0 | 33.6 | (2.4) |
| (Multi-views) | 25% | 0.5460 (0.03) | 0.7730 (0 02) | 0.7001 (0.03) | 0 | 48.0 | (3.8) |
| | 45% | 0.5497 (0.03) | 0.7749 (0.02) | 0.7023 (0.03) | 0 | 69.1 | (5.1) |
| | 63% | 0.5996 (0.02) | 0.7998 (0.01) | 0.7512 (0.02) | 0 | 106.5 | (6.1) |
| | 81% | 0.6026 (0.02) | 0.8013 (0.01) | 0.7575 (0.02) | 0 | 138.9 | (6.9) |

The results show that both Single View and Multi-Views ADS-DRL agents were able to achieve a notable improvement in the crack IoU, with an increase of up to 69% compared to the pure raster scanning under no frame overlap case. Furthermore, the results indicated that the ADS-DRL agent consistently outperformed the raster scanning approach and the random policies across all overlap ratios.

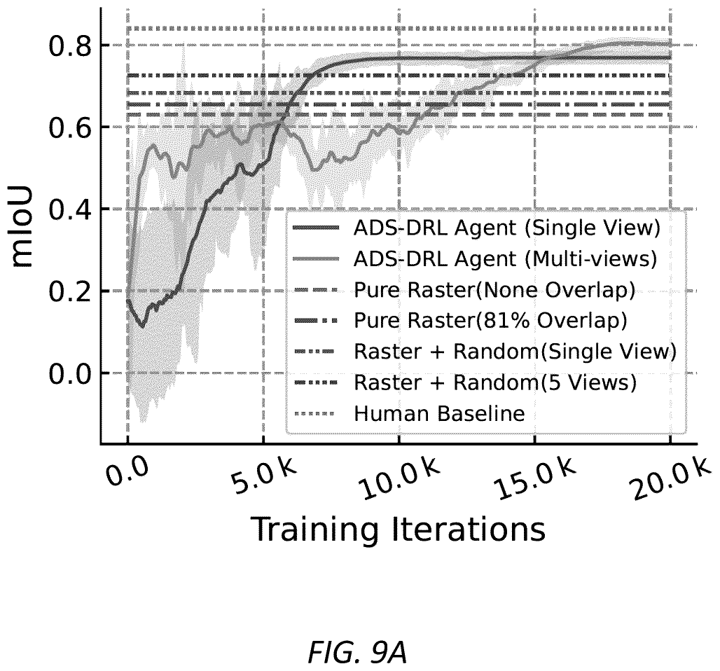

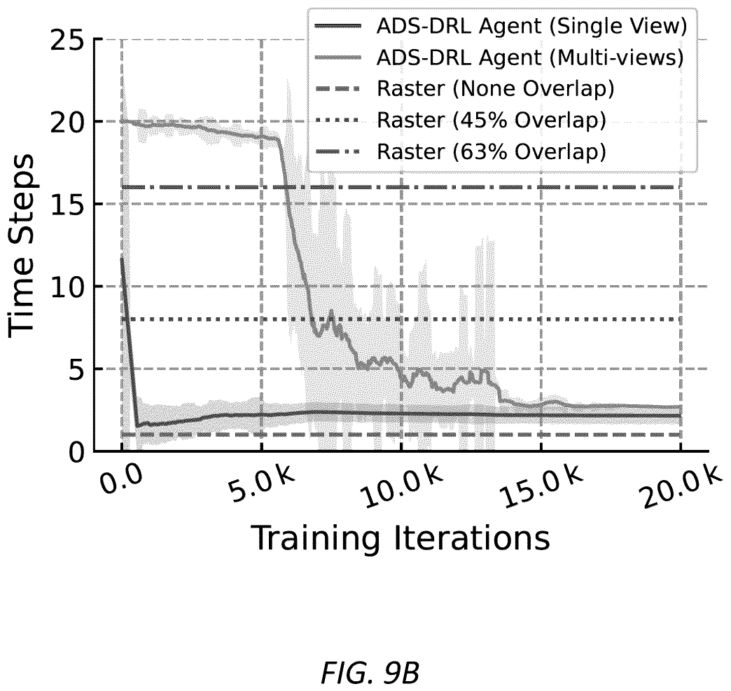

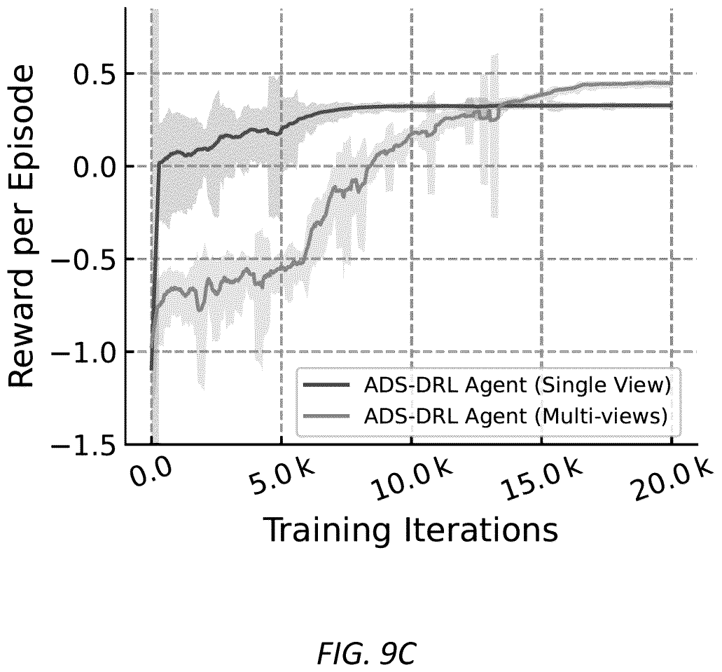

From FIGS. 9A, 9B and 9C, it is evident that the ADS-DRL agent performed better than the multi-views random policy even though it selects significantly fewer viewpoints, suggesting that the learned policy followed systematic patterns in selecting informative viewpoints. To better evaluate the effectiveness of the learned policies of the ADS-DRL agent, a comparison between the multi-views ADS-DRL agent and the human baseline was conducted, which showed that the ADS-DRL agent had acceptable performance, achieving a mIoU score that was only 4 points lower than that of the human oracle. This result highlighted the robotic agent's ability to learn highly effective policies for selecting informative viewpoints, which indicates its potential to approach human level performance in this task. The number of false positive crack instances is also an important metric to be evaluated. The “FP Cracks” columns in Table 1 indicates the number of false positive crack instances. It can be observed that the false positive crack instances were reduced to zero when ADS-DRL agents were used, which is another strong support for formulating the damage detection tasks as active perception problems.

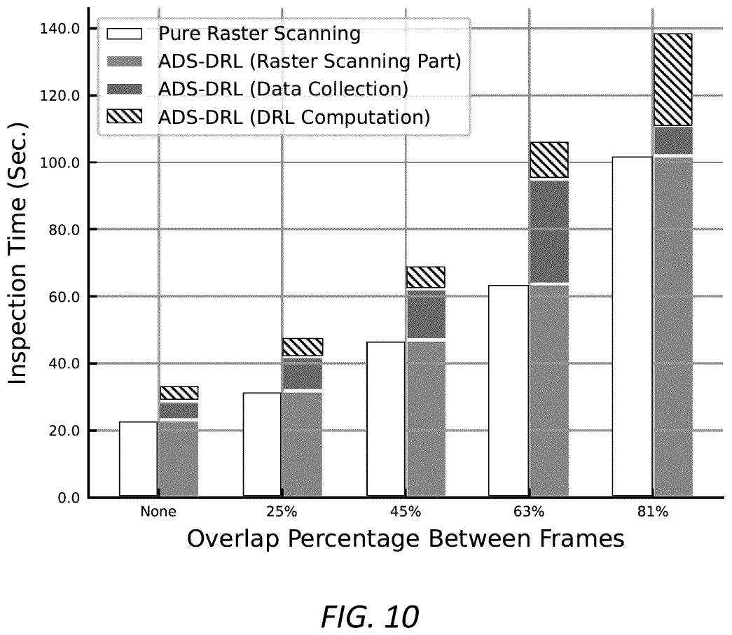

The active detection process also showed promising results in data collection efficiency. A comparison between the non-overlapping version of the ADS-DRL agent and the 83% overlapping raster scanning in Table 1 reveals that the ADS-DRL agent was able to perform a rapid inspection that reduces the total inspection time by more than two times while yielding a 15% higher crack IoU. FIG. 10 shows a detailed breakdown of the total inspection time for different overlap ratios. The comparison of inspection time between raster scanning and the ADS-DRL agent shows that a reasonable amount of computing overhead was added to the total inspection time.

Based on the above, it was concluded that the ADS-DRL agent's performance was superior to that of conventional raster scanning methods. To examiner the behavior that the robotic agent had learned to improve the prediction results, a detailed precision and recall score is listed along with the mIoU in Table 2 below. Table 2 shows that switching from pure raster scanning to the ADS-DRL agent leads to a significant improvement in mIoU. While the recall values of the above-mentioned cases are slightly improved (i.e., less than 4%) when active damage segmentation is used, the precision values are significantly improved (i.e., between 15% and 20%). Therefore, it can be inferred that the improvement in mIoU mainly resulted from the reduction of false positives.

TABLE 2
Precision and Recall Breakdown for Raster Scanning and ADS-DRL Agent under Different
Overlap Ratios. A series of 3 independent trials with different random seeds
are run for each experiment. Mean (μ) and standard deviations (σ) are provided
except for pure raster scanning, where the results are deterministic.

| | | | | ADS-DRL Agent | | |
|---|---|---|---|---|---|---|
| | | | | (Multi-views) | | |
| Frames | Raster Scanning | | | mIoU | Recall | Precision |
| Overlap | mIoU | Recall | Precision | μ(σ) | μ(σ) | μ(σ) |
| None | 0.6315 | 0.8050 | 0.2808 | 0.7230 (0.02) | 0.8396 (0.01) | 0.4833 (0.04) |
| 25% | 0.6824 | 0.8168 | 0.3973 | 0.7730 (0.02) | 0.8428 (0.01) | 0.5987 (0.04) |
| 45% | 0.7013 | 0.8200 | 0.4414 | 0.7749 (0.02) | 0.8541 (0.01) | 0.5963 (0.03) |
| 63% | 0.7309 | 0.8312 | 0.5095 | 0.7998 (0.01) | 0.8692 (0.01) | 0.6614 (0.03) |
| 81% | 0.7306 | 0.8341 | 0.5076 | 0.8013 (0.01) | 0.8661 (0.01) | 0.6731 (0.02) |

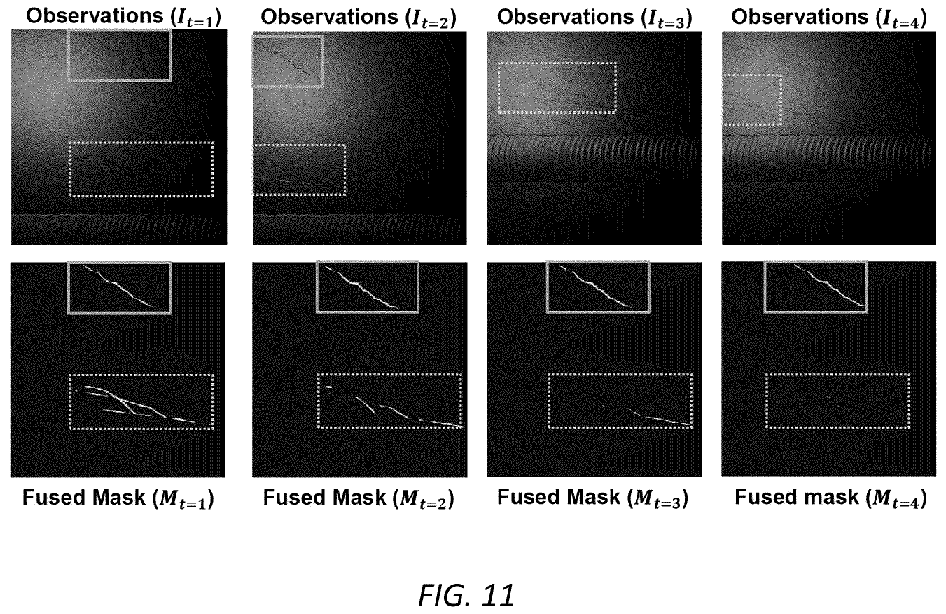

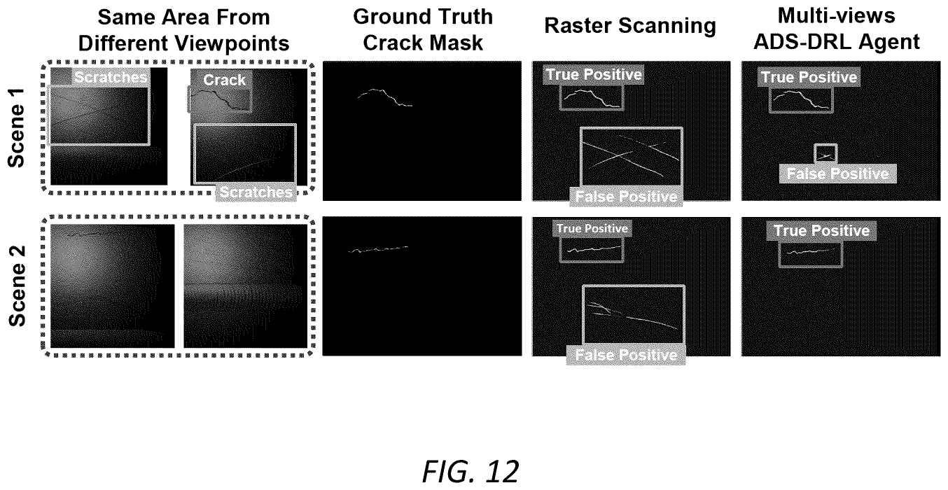

FIG. 11 depicts the above-mentioned behavior where the ADS-DRL agent tried to handle uncertainties and false predictions by moving the camera in the interactive environment. Initially, the robotic agent incorrectly predicted scratches as cracks due to poor lighting conditions. In the following time step, the robotic agent moved its camera so that the crack would be in a brighter area to confirm the existence of the crack. Then, it moved the camera so that the scratches would be in a brighter area to eliminate the false positive predictions made at the first timestep. When the robotic agent finished viewing both cracks and scratches from different viewpoints, it chose to terminate the active perception process and resume raster scanning. This case also shows that putting the crack at the center of the field of view is not always the best option. To achieve a more accurate prediction, the robotic agent learns to leverage the dynamics of the environment to adjust and improve its predictions over time. More prediction examples are shown in FIG. 12, where the raster scanning cannot predict the scratches in darker areas correctly, whereas the ADS-DRL agent was able to distinguish between scratches and cracks.

It was concluded that prediction can be improved due to the reduction of false positive pixels. Given that a higher softmax decision threshold is also capable of reducing the number of false positives. It is natural to consider whether it can produce comparable outcomes to those achieved by the ADS-DRL agent. To answer this question, Table 3 lists the changes in crack IoU, recall, and precision for various softmax thresholds.

TABLE 3
Ablation Analysis of Varying Softmax Decision Threshold (45% Overlap Ratio
Between Frames). A series of 3 independent trials with different random seeds
are run for each experiment. Mean (μ) and standard deviations (σ) are
provided except for pure raster scanning, where the results are deterministic.

| | | | | ADS-DRL Agent | | |
|---|---|---|---|---|---|---|
| | | | | (Multi-views) | | |
| Softmax | Raster Scanning | | | Crack IoU | Recall | Precision |
| Threshold | Crack IoU | Recall | Precision | μ(σ) | μ(σ) | μ(σ) |
| 0.20 | 0.1745 | 0.8755 | 0.1789 | 0.2360 (0.02) | 0.8954 (0.01) | 0.2426 (0.04) |
| 0.35 | 0.2431 | 0.8712 | 0.2552 | 0.3983 (0.02) | 0.8981 (0.01) | 0.4171 (0.03) |
| 0.50 | 0.3567 | 0.8654 | 0.3777 | 0.5271 (0.03) | 0.8801 (0.02) | 0.5642 (0.03) |
| 0.60 | 0.4026 | 0.8206 | 0.4144 | 0.5497 (0.03) | 0.8541 (0.02) | 0.5963 (0.03) |
| 0.70 | 0.3938 | 0.7606 | 0.4495 | 0.4684 (0.02) | 0.8015 (0.03) | 0.5299 (0.02) |
| 0.80 | 0.3250 | 0.5064 | 0.4757 | 0.3726 (0.03) | 0.5571 (0.04) | 0.5295 (0.02) |

The change in crack IoU with respect to the softmax threshold shows an initial increase, followed by a decrease as the threshold continues to rise. Meanwhile, precision monotonically increases as the threshold grows, while recall monotonically decreases as the threshold increases. Raising the decision threshold can potentially reduce false positives, but also introduces false negatives, resulting in lower crack IoU scores and potentially missed cracks. In practice, the cost of a missed damage is much higher than a false positive prediction. Hence, increasing the softmax threshold is not a viable option. Furthermore, the ADS-DRL agent consistently outperformed raster scanning at all softmax thresholds, indicating that raising the threshold would not achieve results comparable to those obtained by the ADS-DRL agent.

In view of the above, the investigations successfully evidenced the ability of the ADS-DRL agent to perform active damage detection. To train and evaluate the robotic agent, photo-realistic synthetic 3D scenes were constructed and a dataset was generated. The robotic agent is preferably capable of moving freely in the 3D scenes and improving the accuracy of the predicted masks by selecting informative viewpoints and fusing the information from those viewpoints. The robotic agent also learned to terminate an episode early, which leads to efficient data collection. Evaluations on metallic surfaces showed that the robotic agent was able to increase the crack IoU by up to 69% compared to conventionally used raster scanning given a similar inspection time under no frame overlap case. Additionally, the robotic agent was able to perform a rapid inspection that reduces the overall inspection time by more than two times while achieving a 15% higher crack IoU than that of the dense raster scanning approach.

As previously noted above, though the foregoing detailed description describes certain aspects of one or more particular embodiments of the invention, alternatives could be adopted by one skilled in the art. As such, and again as was previously noted, it should be understood that the invention is not necessarily limited to any particular embodiment described herein or illustrated in the drawings.

1. A method of detecting cracks in a surface, the method comprising:
training a robotic agent to distinguish with a camera of the robotic agent whether features in the surface are cracks or scratches in the surface; and
inspecting the surface by performing an active damage segmentation (ADS) task that distinguishes between cracks and scratches in the surface by adaptively selecting different viewpoints of the first feature by moving the camera, acquiring observations with the camera corresponding to the different viewpoints, and fusing information obtained from the observations at the different viewpoints.

2. The method of 1, wherein the training step comprises:
training a perception network on a dataset obtained with a simulation environment; and
training a policy network by interacting the policy network with the simulation environment, the interacting comprising Deep Reinforcement Learning (DRL).

3. The method of claim 2, wherein the training of the policy network further comprises:
interacting with the simulation environment to obtain a sequence of observations, actions, and reward signals;
using the reward signal of the sequence to evaluate the quality of the sequence and calculate a gradient of the policy network using a Proximal Policy Optimization (PPO) algorithm based on the observations, actions, and reward signals;
adjusting parameters of the policy network based on the gradient; and then
repeating the interacting, using, and adjusting steps so that the robotic agent is trained to intelligently perform the active damage segmentation task by adaptively selecting each of the different viewpoints of the first feature.

4. The method of claim 1, wherein the active damage segmentation task includes an inference process by which the different viewpoints of the first feature are adaptively selected, the inference process comprising:
commencing a pre-defined raster scan mode with the camera to perform a raster scan of the surface that acquires the observations of the surface;
identifying if a first observation of a first feature acquired at a first viewpoint contains uncertain damage information;
switching to an active perception mode to initiate an active perception episode;
generating a sequence of actions of the robotic agent that move the camera to acquire additional observations of the first feature from the different viewpoints; and then
fusing information obtained from the additional observations to generate a fused mask of the first feature that serves as a final prediction mask.

5. The method of claim 4, wherein the generating step comprises:
passing the first observation through a trained perception module that performs the active perception mode and produces an initial segmentation softmax map; and
determining a second viewpoint for a second observation of the first feature from the initial segmentation softmax map, the first and second observations having overlapping regions.

6. The method of claim 5, wherein the fusing step comprises:
fusing softmax scores from the overlapping regions of the first and second observations; and then
inputting the fused softmax scores to a policy network to generate a fused segmentation softmax map from which is determined a third viewpoint for a third observation of the first feature.

7. The method of claim 6, wherein the generating and fusing steps are repeated as a loop until the robotic agent terminates the loop based on training of the policy network.

8. The method of claim 7, wherein the policy network is trained by interacting the policy network with a simulation environment.

9. The method of claim 8, wherein the interacting comprises Deep Reinforcement Learning (DRL).

10. The method of claim 4, further comprising, after the fusing step:
terminating the active perception mode; and then
switching to the pre-defined raster scan mode to continue the raster scan of the surface.

11. The method of claim 1, wherein the observations are RGB images.

12. An active damage detection system that detects cracks in a surface using the method of claim 1, the active damage detection system comprising the robotic agent, wherein the robotic agent is configured to move the camera in a three-dimensional space relative to the surface.

13. An active damage detection system for detecting cracks in a surface, the active damage detection system comprising:
a robotic agent configured to move a camera in a three-dimensional space relative to the surface, the robotic agent being operable to:
be trained to distinguish with the camera whether a feature in the surface is a crack or a scratch in the surface; and
inspect the surface by performing an active damage segmentation task that distinguishes between cracks and scratches in the surface by adaptively selecting different viewpoints of the feature by moving the camera, acquiring observations with the camera corresponding to the different viewpoints, and fusing information obtained from the observations at the different viewpoints.
